(19) United States
(12) Patent Application Publication
(10) Pub. No.: US 2025/0262914 A1
(43) Pub. Date: Aug. 21, 2025

(54) AIR CONDITIONER FOR VEHICLE

(71) Applicant: Hanon Systems, Daejeon (KR)

(72) Inventors: Woo Hyun CHO, Daejeon (KR); Nam Jun LEE, Daejeon (KR); Sang Ki LEE, Daejeon (KR); Jun Chul AN, Daejeon (KR); Seung Ho LEE, Daejeon (KR)

(73) Assignee: Hanon Systems, Daejeon (KR)

(21) Appl. No.: 19/048,785

(22) Filed: Feb. 7, 2025

(30) Foreign Application Priority Data
Feb. 15, 2024 (KR) 10-2024-0021987

(51) Int. Cl. B60H 1/32; B60H 1/00

(52) U.S. Cl. CPC B60H 1/3233; B60H 1/00521; B60H 1/00528

(57) ABSTRACT

Disclosed is an air conditioner for a vehicle with an improved structure, which prevents condensate generated inside an air conditioning case from leaking through a joint part of cases and ensures smooth drainage of the condensate to a desired location. The air conditioner for a vehicle includes: an air conditioning case in which an air passage and a plurality of air discharge ports are formed; and a cooling heat exchanger and a heating heat exchanger sequentially arranged in the air passage of the air conditioning case in an airflow direction, wherein the air conditioning case is formed by assembling a plurality of cases, and includes a condensate guide part provided at a joint part of the cases to guide the condensate generated inside the air conditioning case toward the interior of the air conditioning case.

### CROSS REFERENCE TO RELATED APPLICATIONS

The present application claims the benefit of priority to Korean Patent Application No. KR 10-2024-0021987, filed Feb. 15, 2024, and is incorporated herein by reference in its entirety.

### BACKGROUND OF THE PRESENT INVENTION

### Field of the Present Invention

The present invention relates to an air conditioner for a vehicle, and more specifically, to an air conditioner for a vehicle which has an improved structure of joint parts of a case, guiding condensate to flow outward.

### Background Art

In general, an air conditioner for a vehicle is a vehicle interior part that is installed for the purpose of cooling or heating the interior of the vehicle in the summer or winter or securing a driver's front and rear view by removing the frost from the windshield during the rainy or winter season. The air conditioner is usually equipped with a heating system and a cooling system to selectively introduce the indoor air or the outdoor air, heat or cool the air, and blow the heated or cooled air to the interior of the vehicle, thereby cooling, heating, or ventilating the interior of the vehicle.

Referring to FIG. 1, a conventional air conditioner 1 for a vehicle includes an air conditioning case 10, an evaporator 20 which is a cooling heat exchanger, an indoor condenser 30 which is a heating heat exchanger, and a temperature door 40. The evaporator 20 and the indoor condenser 30 are sequentially arranged inside the air conditioning case 10 in an air flow direction. Downstream of the indoor condenser 30 in the air flow direction, an electric heater such as a PTC heater can be provided.

The temperature door 40 adjusts the opening degree of a warm air passage 15 passing through the indoor condenser 30 and a cold air passage 14 bypassing the indoor condenser 30, thereby controlling the interior temperature of the vehicle. The air conditioning case 10 includes a plurality of air discharge ports. The air discharge ports include a defrost vent 11, a face vent 12, and a floor vent 13. The defrost vent 11 discharges wind towards the vehicle window, the face vent 12 discharges wind towards passengers' faces, and the floor vent 13 discharges wind towards the passengers' feet.

Additionally, the air conditioning case 10 includes a plurality of mode doors to control the opening degree of the air discharge ports. That is, the air conditioning case 10 includes a defrost door 51 for controlling the opening degree of the defrost vent 11, a vent door 52 for controlling the opening degree of the face vent 12, and a floor door 53 for controlling the opening degree of the floor vent 13. The temperature door 40 is designed in a sliding type, and has a rail-shaped guide groove 60 formed on the inner wall of the air conditioning case 10 to guide the temperature door 40.

The temperature door 40 has a driven gear 43 that meshes with a driving gear 70. The temperature door 40 slidably moves along the guide groove 60 by the rotation of the driving gear 70. The guide groove 60 extends in a convex arc shape in the wind direction, and the temperature door 40 is correspondingly curved to fit the guide groove 60. The driving gear 70 has a drive shaft 71 extending in the width direction of the door.

Referring further to FIG. 2, the conventional air conditioner for the vehicle includes an air conditioning case 10, which is assembled by joining a left case 21 and a right case 22 in a vehicle width direction and combining the left and right cases 21 and 22 with a lower case 23 in a vertical direction. The conventional air conditioner for the vehicle includes a joint part inevitably formed during the assembly of the cases, so condensate generated inside the air conditioning case 10 can be forced out through the joint part and drip into the cabin room.

Specifically, condensate leakage may occur at the joint part of the air conditioning case 10 which faces the air passing through the evaporator 20. During a cooling mode, the condensate and the air passing through the evaporator 20 can move together, and in this case, the condensate is more likely to leak through the joint part of the air conditioning case 10. That is, the condensate generated inside the air conditioning case 10 may leak out through the joint part of the cases to unintended locations instead of being drained properly through a drain hole, causing potential problems.

### SUMMARY OF THE INVENTION

Accordingly, the present invention has been made to solve the above-mentioned problems occurring in the prior arts, and it is an objective of the present invention to provide an air conditioner for a vehicle with an improved structure, which prevents condensate generated inside an air conditioning case from leaking through a joint part of cases and ensures smooth drainage of the condensate to a desired location.

To accomplish the above object, according to the present invention, there is provided an air conditioner for a vehicle including: an air conditioning case in which an air passage and a plurality of air discharge ports are formed; and a cooling heat exchanger and a heating heat exchanger sequentially arranged in the air passage of the air conditioning case in an airflow direction, wherein the air conditioning case is formed by assembling a plurality of cases, and includes a condensate guide part provided at a joint part of the cases to guide the condensate generated inside the air conditioning case toward the interior of the air conditioning case.

The condensate guide part includes a drainage hole formed at the bottom of the joint part to communicate with the interior of the air conditioning case.

The joint part overlap in multiple layers.

The joint part includes an inner joint part and an outer joint part, and the inner joint part is separated from the outer joint part.

The inner joint part and the outer joint part are separated in the thickness direction of the air conditioning case.

The condensate guide part includes an internal channel through which condensate running down along the joint part flows.

The drainage hole connects the internal channel to the interior of the air conditioning case.

The outer joint part prevents the condensate generated inside the air conditioning case from being discharged to the exterior, and the drainage hole is formed in the inner joint part and guides the condensate into the interior of the air conditioning case.

The condensate guide part includes an internal channel through which the condensate running down along the joint part flows, and the drainage hole includes a side hole connecting the joint part to the internal channel and a bottom hole connecting the internal channel to the interior of the air conditioning case.

The air conditioning case includes a left case and a right case, and a separator is interposed between the left case and the right case to divide the internal air passage of the air conditioning case into the left and right.

The Joint part is formed between the left case and the separator and between the right case and the separator.

A lower case is provided beneath the left case, the separator, and the right case, and the joint part is formed between the lower case and the bottoms of the left case, the separator, and the right case.

The lower case includes a lower drainage hole which guides the condensate, guided between the inner joint part and the outer joint part, toward the interior of the air conditioning case.

The drainage holes are respectively formed in the left case and the right case.

The condensate guide part is formed at a joint part section of the air conditioning case facing the cooling heat exchanger.

The inner joint part and the outer joint part are each configured with a tongue-and-groove structure.

The outer joint part is positioned further outward than the inner joint part 201 and forms a double-sealing structure.

The drainage hole prevents the condensate from leaking through the joint part to the exterior of the air conditioning case and guides the condensate to flow into the interior of the air conditioning case.

The air conditioner for the vehicle according to the present invention can prevent condensate generated inside an air conditioning case from unintentionally leaking through the joint part of cases and ensure smooth drainage of the condensate to a desired location, thus effectively preventing the condensate from dripping into the cabin room.

Additionally, the air conditioner for the vehicle according to the present invention can optimize the location of the condensate guide part, thus effectively preventing leakage of condensate through the joint part of the air conditioning case, even when the condensate and the air passing through the evaporator move together.

### BRIEF DESCRIPTION OF THE DRAWINGS

FIG. 1 is a side cross-sectional view of a conventional air conditioner for a vehicle.

FIG. 2 is a front view of the conventional air conditioner for the vehicle.

FIG. 3 is a side cross-sectional view of an air conditioner for a vehicle according to an embodiment of the present invention.

FIG. 4 is a front view of the air conditioner for the vehicle according to an embodiment of the present invention.

FIG. 5 is a cross-sectional view taken along line A-A of FIG. 4.

FIG. 6 is a cross-sectional view taken along line B-B of FIG. 4.

FIG. 7 is an exploded perspective view illustrating a left case, a separator, and a right case according to an embodiment of the present invention.

FIG. 8 is a side view of the right case according to an embodiment of the present invention.

FIG. 9 is a perspective view of the right case according to an embodiment of the present invention.

FIG. 10 is a rear perspective view of the right case according to an embodiment of the present invention.

FIG. 11 is a plan view of a lower case according to an embodiment of the present invention.

FIG. 12 is an enlarged plan view of an area “A” in FIG. 11.

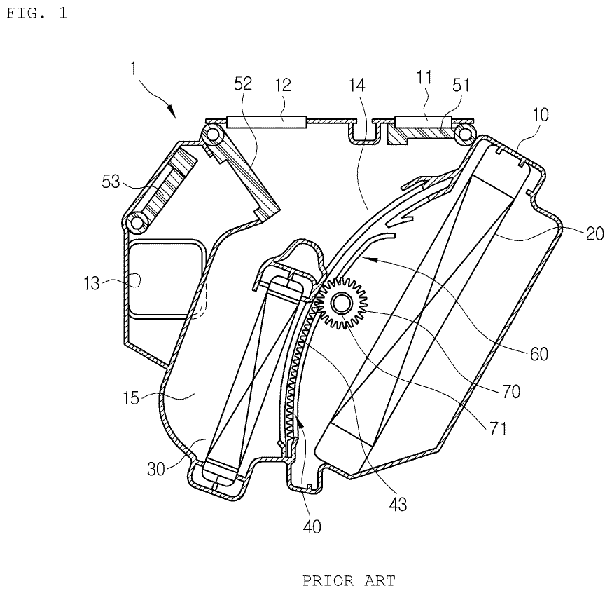

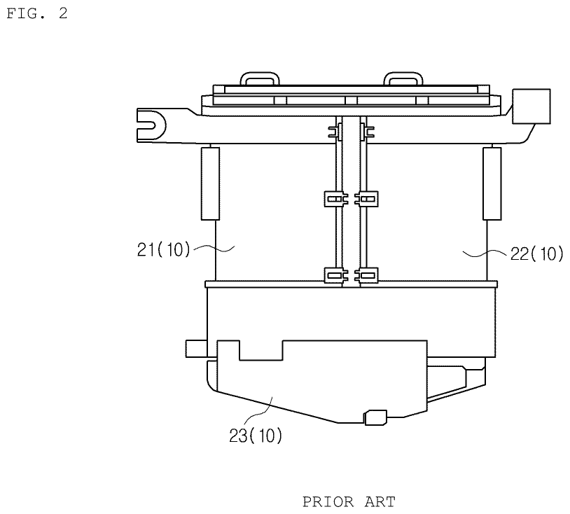

### DETAILED DESCRIPTION OF THE PREFERRED EMBODIMENT

Hereinafter, referring to the drawings, the technical configuration of an air conditioner for a vehicle will be described in detail.

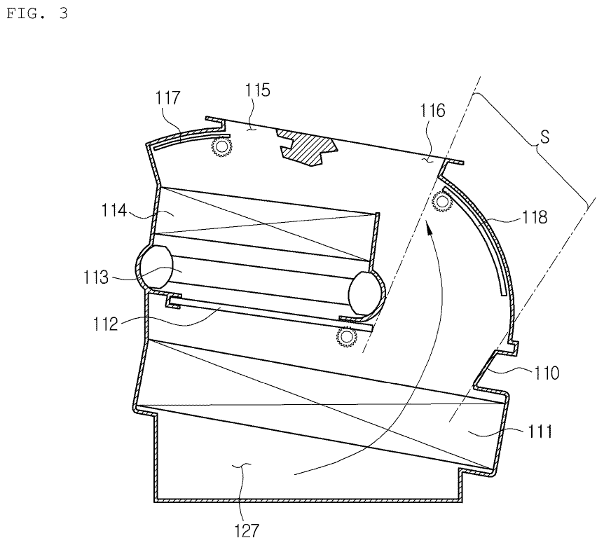

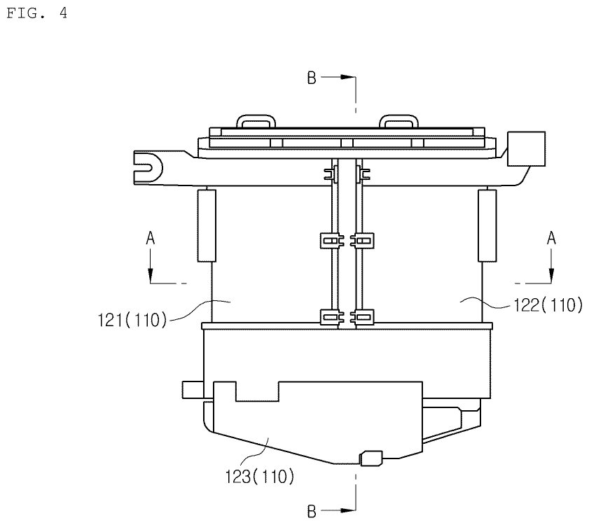

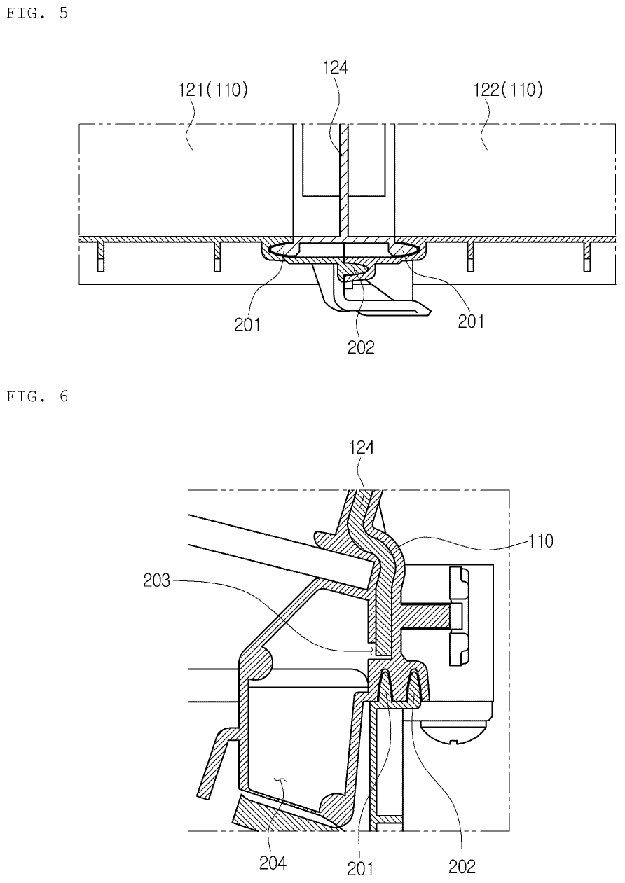

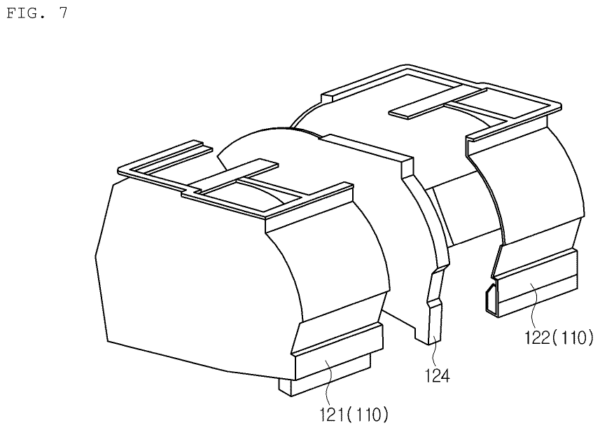

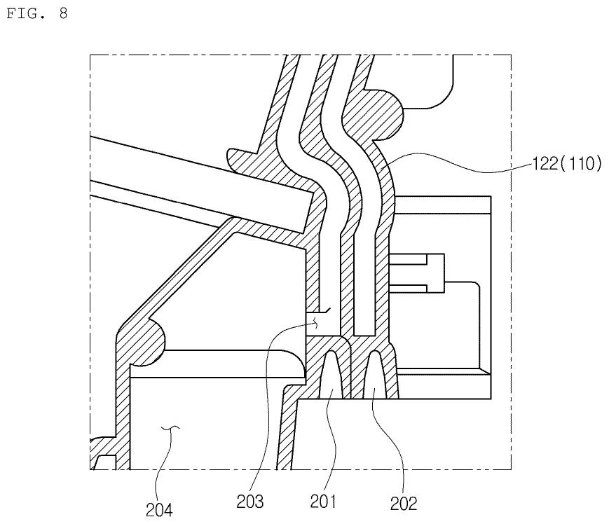

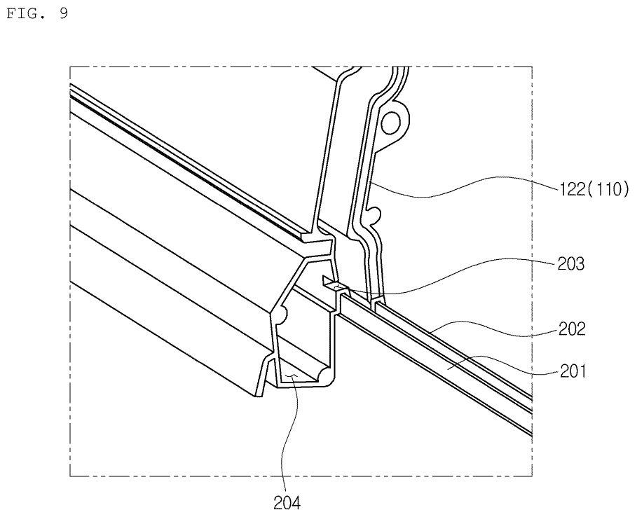

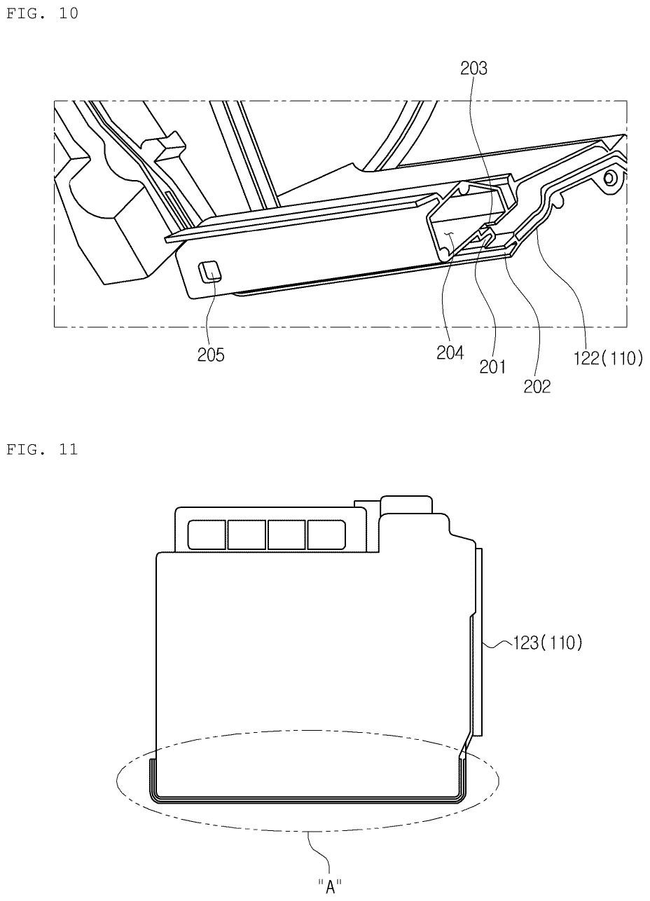

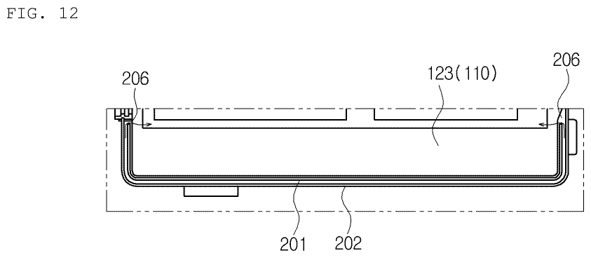

Referring to FIGS. 3 to 12, the air conditioner for a vehicle according to an embodiment of the present invention is a slim-type air conditioner with a horizontally arranged heat exchanger type, and has a relatively thin vertical width. The air conditioner for a vehicle according to an embodiment of the present invention includes an air conditioning case 110, a cooling heat exchanger, a heating heat exchanger, and a door. In the description below, the left-right direction in FIG. 3 corresponds to the vehicle's front-rear direction, while the left-right direction in FIG. 4 corresponds to the vehicle's width direction.

The air conditioning case 110 includes an air passage and is a slim type with a narrow vertical width. The air conditioning case 110 includes an air inflow port 127 and a plurality of air discharge ports. An air blower for blowing air into the air conditioning case 110 is connected to the air inflow port 127. The air blower selectively introduces inside air or outside air and blows the air into the air conditioning case 110.

Moreover, the air inflow port 127 is located below the cooling heat exchanger so that air flows from the bottom to the top. The air discharge ports of the air conditioning case 110 includes a defrost vent 115, a face vent 116, and a floor vent. The defrost vent 115 is formed to direct air toward the vehicle windows, the face vent 116 is formed to direct air toward the front seat passengers' faces, and the floor vent is formed to direct air toward the front seat passengers' feet. The floor vent (not shown) is formed on the side of the air conditioning case 110 to guide air toward the lower portion of the vehicle through a duct.

The cooling heat exchanger is an evaporator 111, and the heating heat exchanger is an indoor condenser 113. An electric heater 114 such as a PTC heater is provided downstream of the indoor condenser 113 in the airflow direction. The evaporator 111 and the indoor condenser 113 are connected in a refrigerant circulation line connecting a compressor, an expansion valve, etc., to act as a cooling means or a heating means depending on the refrigerant state. That is, the refrigerant passing through the evaporator 111 exchanges heat with air to cool the air, and the refrigerant passing through the indoor condenser 113 exchanges heat with air to heat the air.

The evaporator 111 and the indoor condenser 113 are sequentially arranged in the air passage of the air conditioning case 110 in the airflow direction. The evaporator 111, the indoor condenser 113, and the electric heater 114 are all arranged horizontally. That is, the internal passage of the air conditioning case 110 is vertically oriented relative to the ground, directing the airflow route from the lower part to the upper part in the direction of gravity. In addition, the cooling heat exchanger and the heating heat exchanger on the internal passage are arranged sequentially from the bottom to the top in the direction of gravity corresponding to the air flow route.

As described above, the heat exchangers are arranged horizontally relative to the ground surface or inclined at a predetermined angle to be close to the horizontal. That is, air is introduced into the air inflow port 127 at the lower side of the air conditioning case 110 and flows upwards. From below, the evaporator 111, the indoor condenser 113, and the electric heater 114 are arranged in sequence.

The air conditioner for a vehicle includes a temperature door 112 and a plurality of mode doors. The temperature door 112 is placed between the evaporator 111 and the indoor condenser 113. The temperature door 112 controls the opening degree between the warm air passage passing through the indoor condenser 113 and the cold air passage bypassing the indoor condenser 113 to adjust the interior temperature of the vehicle. That is, the temperature door 112 adjusts the amount of air passing through or the amount of air bypassing the indoor condenser 113 and the electric heater 114 according to the position thereof.

The temperature door 112 is a plate door that slides horizontally within the air conditioning case 110, adjusting the opening degree between the cold air passage and the warm air passage. The sliding-type temperature door 112 helps reduce the height of the air conditioning case 110. The mode doors include a defrost door 117 for adjusting the opening degree of the defrost vent 115, a vent door 118 for adjusting the opening degree of the face vent 116, and a floor door for adjusting the opening degree of the floor vent.

A separator 124 which divides the inside of the air conditioning case 110 into the left and right in a vehicle width direction is provided within the air conditioning case 110. The separator 124 divides the air passage of the air conditioning case 110 into the left and right, enabling right and left independent air conditioning for the driver's seat and the front passenger's seat. Furthermore, the air conditioning case 110 is formed by assembling a plurality of cases. That is, the air conditioning case 110 is formed by assembling a left case 121, a right case 122, and a lower case 123. A separator 124 is interposed between the left case 121 and the right case 122.

The air conditioner for the vehicle according to an embodiment of the present invention includes a condensate guide part. The condensate guide part is provided at a joint part of the case to guide the condensate generated inside the air conditioning case 110 toward the interior of the air conditioning case rather than the exterior. In this case, the joint parts overlap in multiple layers. That is, the joint parts include an inner joint part 201 and an outer joint part 202, and the inner joint part 201 is configured to be separated from the outer joint part 202 in the thickness direction of the air conditioning case.

As described above, a double-layer joint parts are formed on the air conditioning case 110 and the separator 124, and the condensate guide part includes a drainage hole and an internal channel 204. The internal channel 204 is located at the bottom of the joint part of the air conditioning case 110 and serves as a passage through which condensate running down along the joint parts flows. The internal channel 204 connects to the interior of the air conditioning case 110, preventing the condensate from flowing outside the air conditioning case 110 and ensuring the condensate to flow inward.

The joint parts, which serve as coupling surfaces, are formed between the cases. That is, the joint parts are formed between the left case 121 and the separator 124 and between the right case 122 and the separator 124. Additionally, the lower case 123 is assembled at the bottoms of the left case 121, the separator 124, and the right case 122. Joint parts are also formed between the bottoms of the left case 121, the separator 124, and the right case 122 and the lower case 123. The joint parts adopt a tongue-and-groove structure that combines protrusions and recesses.

The drainage hole is formed at the bottom of the joint part and communicates with the interior of the air conditioning case 110. That is, the drainage hole connects the internal channel 204 to the interior of the air conditioning case 110, thereby preventing the condensate from leaking through the joint parts to the exterior of the air conditioning case and guiding the condensate to flow into the interior of the air conditioning case. The internal channel 204 serves as a passage through which the condensate running down along the joint parts flows.

The inner joint part 201 and the outer joint part 202 are formed by the tongue-and-groove structure, and the outer joint part 202 is positioned further outward than the inner joint part 201 and forms a double-sealing structure. The outer joint part 202 functions as a dam that prevents the condensate generated inside the air conditioning case from leaking to the outside. The condensate flowing down along the joint part is directed inward.

The drainage hole is formed in the inner joint part 201 and guides the condensate into the interior of the air conditioning case 110. The drainage hole includes a side hole 203 and a bottom hole 205. The side hole 203 laterally penetrates the side of the air conditioning case 110 to connect the joint part with the internal channel 204. The condensate flowing down along the joint part is guided through the side hole 203 into the internal channel 204. Additionally, the drainage holes are respectively formed in the left case 121 and the right case 122.

The bottom hole 205 penetrates the bottom surface of the air conditioning case 110 in a vertical direction to connect the internal channel 204 with the interior of the air conditioning case 110. The condensate flowing along the internal channel 204 falls into the interior of the air conditioning case 110 through the bottom hole 205. Within the air conditioning case 110, condensate is inevitably generated during the refrigerant evaporation process in the evaporator. The condensate is typically discharged to the exterior through a drain hole formed at the bottom surface of the air conditioning case 110.

However, a portion of the condensate generated inside the air conditioning case 110 may be forced out through tiny gaps between the joint parts of the cases due to strong wind blowing from a blower, unintentionally dripping into the cabin room. The unintended leakage of condensate into the cabin room can cause various problems. Therefore, it is necessary to fundamentally prevent the condensate inside the air conditioning case 110 from getting out of the air conditioning case 110.

Accordingly, the joint parts are configured to overlap in multiple layers, either double or triple. The multi-layered joint parts significantly contribute to preventing the condensate inside the air conditioning case 110 from getting out of the air conditioning case 110. In this case, merely forming multi-layered joint parts is not sufficient to perfectly block the condensate inside the air conditioning case 110. The reason is why it is possible for the condensate to get out of the air conditioning case 110 through very small gaps by high pressure wind using a blower.

Finally, the condensate guide part including the internal channel 204, the side hole 203, and the bottom hole 205 guides the condensate to direct the interior of the air conditioning case 110 and to be discharged through the drain hole. This minimizes the possibility of condensate unintentionally escaping to the exterior of the air conditioning case 110, reducing it to nearly zero.

Additionally, the condensate guide part is formed at the joint part of the air conditioning case 110 that faces air passing through the evaporator 111. Specifically, as shown in FIG. 3, the condensate guide part is located at the joint part section (S) of the air conditioning case facing the evaporator 111. By optimizing the location of the condensate guide part, the system effectively prevents condensate from leaking through the joint parts of the air conditioning case 110, even when air passing through the evaporator 111 and condensate move together.

Meanwhile, a lower drainage hole 206 is formed in the lower case 123. The lower drainage hole 206 guides the condensate, guided between the inner joint part 201 and the outer joint part 202, toward the interior of the air conditioning case 110. Accordingly, the condensate that could be discharged through the joint parts among the left case 121, the separator 124, and the right case 122 is guided to the interior of the air conditioning case 110 through the internal channel 204, the side hole 203, and the bottom hole 205. Moreover, the condensate that could be discharged through the joint parts between the upper cases (left and right cases) and the lower case is guided to the interior of the air conditioning case 110 through the lower drainage hole 206.

The air conditioner for a vehicle according to the present invention has been described with reference to the embodiments shown in the drawings, but the embodiments are merely examples. It should be apparent that modifications and variations can be made by persons skilled without deviating from the spirit or scope of the present invention. Therefore, the true scope of technical protection should be defined by the spirit of the appended claims.

What is claimed is:

1. An air conditioner for a vehicle comprising:
an air conditioning case in which an air passage and a plurality of air discharge ports are formed; and
a cooling heat exchanger and a heating heat exchanger sequentially arranged in the air passage of the air conditioning case in an airflow direction,
wherein the air conditioning case is formed by assembling a plurality of cases, and includes a condensate guide part provided at a joint part of the cases to guide the condensate generated inside the air conditioning case toward the interior of the air conditioning case.

2. The air conditioner according to claim 1, wherein the condensate guide part includes a drainage hole formed at the bottom of the joint part to communicate with the interior of the air conditioning case.

3. The air conditioner according to claim 2, wherein the joint part overlap in multiple layers.

4. The air conditioner according to claim 3, wherein the joint part includes an inner joint part and an outer joint part, and
wherein the inner joint part is separated from the outer joint part.

5. The air conditioner according to claim 4, wherein the inner joint part and the outer joint part are separated in the thickness direction of the air conditioning case.

6. The air conditioner according to claim 3, wherein the condensate guide part includes an internal channel through which condensate running down along the joint part flows.

7. The air conditioner according to claim 6, wherein the drainage hole connects the internal channel to the interior of the air conditioning case.

8. The air conditioner according to claim 4, wherein the outer joint part prevents the condensate generated inside the air conditioning case from being discharged to the exterior, and
wherein the drainage hole is formed in the inner joint part and guides the condensate into the interior of the air conditioning case.

9. The air conditioner according to claim 2, wherein the condensate guide part includes an internal channel through which the condensate running down along the joint part flows, and
wherein the drainage hole includes a side hole connecting the joint part to the internal channel and a bottom hole connecting the internal channel to the interior of the air conditioning case.

10. The air conditioner according to claim 4, wherein the air conditioning case includes a left case and a right case, and
wherein a separator is interposed between the left case and the right case to divide the internal air passage of the air conditioning case into the left and right.

11. The air conditioner according to claim 10, wherein the joint part is formed between the left case and the separator and between the right case and the separator.

12. The air conditioner according to claim 11, wherein a lower case is provided beneath the left case, the separator, and the right case, and the joint part is formed between the lower case and the bottoms of the left case, the separator, and the right case.

13. The air conditioner according to claim 12, wherein the lower case includes a lower drainage hole which guides the condensate, guided between the inner joint part and the outer joint part, toward the interior of the air conditioning case.

14. The air conditioner according to claim 12, wherein the drainage holes are respectively formed in the left case and the right case.

15. The air conditioner according to claim 4, wherein the condensate guide part is formed at a joint part section of the air conditioning case facing the cooling heat exchanger.

16. The air conditioner according to claim 4, wherein the inner joint part and the outer joint part are each configured with a tongue-and-groove structure.

17. The air conditioner according to claim 16, wherein the outer joint part is positioned further outward than the inner joint part and forms a double-sealing structure.

18. The air conditioner according to claim 7, wherein the drainage hole prevents the condensate from leaking through the joint part to the exterior of the air conditioning case and guides the condensate to flow into the interior of the air conditioning case.
